(19) United States
(12) Patent Application Publication
(10) Pub. No.: US 2026/0298496 A1
(43) Pub. Date: Oct. 1, 2026

(54) AIR CONDITIONING CIRCUIT AND MULTI-SPLIT SYSTEM

(71) Applicants: FOSHAN SHUNDE MIDEA ELECTRIC SCIENCE AND TECHNOLOGY CO., LTD., Foshan (CN); GD MIDEA AIR-CONDITIONING EQUIPMENT CO., LTD., Foshan (CN)

(72) Inventors: Weiyou YU, Foshan (CN); Wenkai ZHANG, Foshan (CN)

(21) Appl. No.: 19/479,045

(22) PCT Filed: Apr. 28, 2024
(86) PCT No.: PCT/CN2024/090381

§ 371 Date: Oct. 27, 2025

(30) Foreign Application Priority Data
Apr. 27, 2023 (CN) 202310479491.1

(51) Int. Cl. F24F 11/88; F24F 1/22; F24F 11/46; H04B 3/54

(52) U.S. Cl. CPC F24F 11/88; F24F 1/22; F24F 11/46; H04B 3/54

(57) ABSTRACT

The present disclosure discloses an air conditioning circuit and a multi-split system, wherein the air conditioning circuit includes an outdoor unit circuit (100), a carrier communication cable (200), and an indoor unit circuit (300). The outdoor unit circuit (100) includes an outdoor unit power supply circuit (110). The carrier communication cable (200) is connected to an output terminal of the outdoor unit power supply circuit (110) to obtain carrier power. The indoor unit circuit (300) includes a power supply input terminal (310), an indoor unit power supply circuit (320), a switching device (330), and a wired controller circuit (340). The indoor unit power supply circuit (320) obtains power from the power supply input terminal through the switching device (330), a control terminal of the switching device (330) is connected to the carrier communication cable (200), the wired controller circuit (340) is connected to the carrier communication cable (200) to obtain power, the wired controller circuit (340) is provided with a standby switch (341) connected to the carrier communication cable (200), and the standby switch (341) is configured to, when closed, trigger an overload protection function of the outdoor unit power supply circuit (110) through the carrier communication cable (200).

### CROSS-REFERENCE TO RELATED APPLICATION

The present application claims priority to Chinese Patent Application No. 202310479491.1, entitled “AIR CONDITIONING CIRCUIT AND MULTI-SPLIT SYSTEM” and filed on Apr. 27, 2023, the entire contents of which are incorporated herein by reference.

### FIELD

The present disclosure relates to the technical field of air conditioning circuits, and in particular, to an air conditioning circuit and a multi-split system.

### BACKGROUND

With the improvement of living standards, the idea of energy-saving and consumption-reducing lifestyle has gained widespread acceptance, and many countries have issued relevant laws and regulations to impose corresponding constraints. Currently, most air conditioning systems are equipped with low standby power consumption control schemes, such as cutting off a power supply of a single unit during standby or using an electronic switching circuit to disconnect some loop loads. However, a switching power supply remains in an operational state and cannot be completely shut down.

Although satisfactory standby effects have been achieved in related technical schemes, for example, standby power consumption is controlled within 1 W or 2 W, these related technical schemes also come at considerable technical costs and require an additional control circuit and a more efficient device. Moreover, further reducing the standby power consumption presents greater technical challenges and cost issues.

### SUMMARY

The present disclosure aims to at least partially resolve one of technical problems existing in the related art, and provides an air conditioning circuit and a multi-split system.

In one aspect of the present disclosure, some embodiments of the present disclosure provide an air conditioning circuit, including an outdoor unit circuit, a carrier communication cable, and an indoor unit circuit.

The outdoor unit circuit includes an outdoor unit power supply circuit.

The carrier communication cable is connected to an output terminal of the outdoor unit power supply circuit to obtain carrier power.

The indoor unit circuit includes a power supply input terminal, an indoor unit power supply circuit, a switching device, and a wired controller circuit. The indoor unit power supply circuit obtains power from the power supply input terminal through the switching device, a control terminal of the switching device is connected to the carrier communication cable, the wired controller circuit is connected to the carrier communication cable to obtain power, the wired controller circuit is provided with a standby switch connected to the carrier communication cable, and the standby switch is configured to, when closed, trigger an overload protection function of the outdoor unit power supply circuit through the carrier communication cable.

According to the air conditioning circuit provided by some embodiments of the present disclosure, the carrier communication cable includes a first cable connected to a positive output terminal of the outdoor unit power supply circuit, one end of the standby switch is connected to the first cable, and the other end of the standby switch is grounded.

According to the air conditioning circuit provided by some embodiments of the present disclosure, the carrier communication cable includes a first cable connected to a positive output terminal of the outdoor unit power supply circuit and a second cable connected to a negative output terminal of the outdoor unit power supply circuit, one end of the standby switch is connected to the first cable, and the other end of the standby switch is connected to the second cable.

According to the air conditioning circuit provided by some embodiments of the present disclosure, the switching device is a relay or a contactor.

According to the air conditioning circuit provided by some embodiments of the present disclosure, the power supply input terminal includes a line input terminal and a neutral input terminal, the line input terminal is connected to the indoor unit power supply circuit through a third cable, the neutral input terminal is connected to the indoor unit power supply circuit through a fourth cable, the switching device includes a first normally-open contact connected in series in the third cable, and a coil of the switching device is connected to the carrier communication cable.

According to the air conditioning circuit provided by some embodiments of the present disclosure, the switching device further includes a second normally-open contact connected in series in the fourth cable.

According to the air conditioning circuit provided by some embodiments of the present disclosure, a plurality of indoor unit circuits are provided, and control terminals of switching devices in the plurality of indoor unit circuits are all connected to the carrier communication cable.

The air conditioning circuit according to some embodiments of the present disclosure further includes an indoor unit power supply cable connected to an indoor unit power supply. The indoor unit power supply cable is provided with a plurality of distribution boxes for supplying power to the power supply input terminal.

According to the air conditioning circuit provided by some embodiments of the present disclosure, the outdoor unit circuit further includes an outdoor unit communication circuit coupled to the carrier communication cable, and the indoor unit circuit further includes an indoor unit communication circuit coupled to the carrier communication cable.

According to the air conditioning circuit provided by some embodiments of the present disclosure, the outdoor unit communication circuit is connected to the first cable through a first capacitor and to the second cable through a second capacitor; and the indoor unit communication circuit is connected to the first cable through a third capacitor and to the second cable through a fourth capacitor.

According to the air conditioning circuit provided by some embodiments of the present disclosure, the positive output terminal of the outdoor unit power supply circuit is connected to the first cable through a first inductor, and the negative output terminal of the outdoor unit power supply circuit is connected to the second cable through a second inductor; and the first cable is connected to the one end of the standby switch through a third inductor, and the second cable is connected to the other end of the standby switch through a fourth inductor.

In another aspect of the present disclosure, an embodiment of the present disclosure provides a multi-split system, including an inner unit, an outer unit, and the air conditioning circuit according to the embodiments of the first aspect. The inner unit includes the indoor unit circuit in the air conditioning circuit, and the outer unit includes the outdoor unit circuit in the air conditioning circuit.

Other features and advantages of the present disclosure are set forth in the following specification, and become partly clear from the specification, or learned by implementing the present disclosure. Objectives and other advantages of the present disclosure may be achieved and obtained by structures particularly indicated in the specification, claims, and accompanying drawings.

### BRIEF DESCRIPTION OF DRAWINGS

Accompanying drawings are used to provide a further understanding of technical schemes of the present disclosure and constitute part of this specification, serve to explain the technical schemes of the present disclosure together with embodiments of the present disclosure, and do not constitute a limitation on the technical schemes of the present disclosure.

The present disclosure is further described below with reference to the accompanying drawings and the embodiments.

FIG. 1 is a schematic structural diagram of an air conditioning circuit according to a first embodiment of the present disclosure;

FIG. 2 is a schematic structural diagram of an air conditioning circuit according to a second embodiment of the present disclosure;

FIG. 3 is a schematic structural diagram of an air conditioning circuit according to a third embodiment of the present disclosure;

FIG. 4 is a schematic structural diagram of an air conditioning circuit according to a fourth embodiment of the present disclosure;

FIG. 5 is a schematic structural diagram of an air conditioning circuit according to a fifth embodiment of the present disclosure; and

FIG. 6 is a schematic diagram illustrating state switching of an air conditioner according to an embodiment of the present disclosure.

### DETAILED DESCRIPTION

This section will give a detailed description of specific embodiments of the present disclosure. Some embodiments of the present disclosure are shown in the accompanying drawings. The function of the accompanying drawings is to use drawings to supplement the description of the text part of the description, such that those having ordinary skills in the art can intuitively and vividly understand each technical feature and the overall technical scheme of the present disclosure, but the accompanying drawings are not intended to be construed as limiting the scope of protection of the present disclosure.

In the description of the embodiments of the present disclosure, the term “at least one” means one or more, the term “plurality of” (or multiple) means at least two, the term such as “greater than,” “less than,” “exceed” or variants thereof prior to a number or series of numbers is understood to not include the number adjacent to the term. The term “several” prior to a number or series of numbers is understood to include the number adjacent to the term “at least,” and all subsequent numbers or integers that could logically be included, as clear from context. “At least one” refers to one or more. The expression “at least one of the following” and similar expressions refer to any combination of the listed items, including a single item or any combination of multiple items. If used herein, the terms such as “first,” “second,” and the like are merely used for distinguishing technical features, and are not intended to indicate or imply relative importance, or implicitly point out the number of the indicated technical features, or implicitly point out the precedence order of the indicated technical features.

It is to be noted that in the embodiments of the present disclosure, the terms such as “configure,” “install/mount” and “connect” should be understood in a broad sense, and those having ordinary skills in the art can reasonably determine the specific meanings of the above terms in the present disclosure based on the specific contents of the technical scheme. For example, the term “connection” may refer to a mechanical connection, an electrical connection, or a connection enabling mutual communication; and it may be a direct connection or an indirect connection via an intermediate medium.

It should be noted that the technical features involved in the various embodiments of the present application described below can be combined with each other if there is no conflict.

With the improvement of living standards, the idea of energy-saving and consumption-reducing lifestyle has gained widespread acceptance, and many countries have issued relevant laws and regulations to impose corresponding constraints. Currently, most air conditioning systems are equipped with low standby power consumption control schemes, such as cutting off a power supply of a single unit during standby or using an electronic switching circuit to disconnect some loop loads. However, a switching power supply remains in an operational state and cannot be completely shut down.

Although satisfactory standby effects have been achieved in related technical schemes, for example, standby power consumption is controlled within 1 W or 2 W, these related technical schemes also come at considerable technical costs and require an additional control circuit and a more efficient device. Moreover, further reducing the standby power consumption presents greater technical challenges and cost issues.

In view of the above, embodiments of the present disclosure provide an air conditioning circuit and a multi-split system. When an air conditioning system operates normally, in an outdoor unit circuit, the outdoor unit power supply circuit operates normally, and an output terminal of the outdoor unit power supply circuit provides carrier power to a carrier communication cable; and in an indoor unit circuit, the carrier communication cable outputs power to a switching device and a wired controller circuit, which can enable the switching device to be in an activated state, such that power from a power supply input terminal can be supplied to the indoor unit power supply circuit through the switching device, allowing both the indoor unit power supply circuit and the wired controller circuit to be powered up and operate normally. When the air conditioning system needs to enter a standby state, a user can press a standby switch in the wired controller circuit to close the standby switch, thereby triggering an overload protection function of the outdoor unit power supply circuit, such that the outdoor unit power supply circuit enters an overload protection state. To be specific, the outdoor unit power supply circuit does not operate, all outdoor unit loads connected to the outdoor unit power supply circuit do not operate at this time, the carrier communication cable does not supply power to the switching device and the wired controller circuit, the switching device also changes from an activated state to a deactivated state, and consequently, the power from the power supply input terminal cannot be supplied to the indoor unit power supply circuit through the switching device, the indoor unit power supply circuit does not operate, and all indoor unit loads connected to the indoor unit power supply circuit do not operate at this time. The air conditioning circuit utilizes the standby switch to trigger the overload protection function of the outdoor unit power supply circuit, and after the standby switch is pressed to enter the standby state, all switching power supply circuits and loads in the air conditioning system do not operate, thereby achieving ultra-low standby power consumption control for the air conditioning system, low costs, and ease of implementation.

The embodiments of the present disclosure are further described in detail below with reference to accompanying drawings.

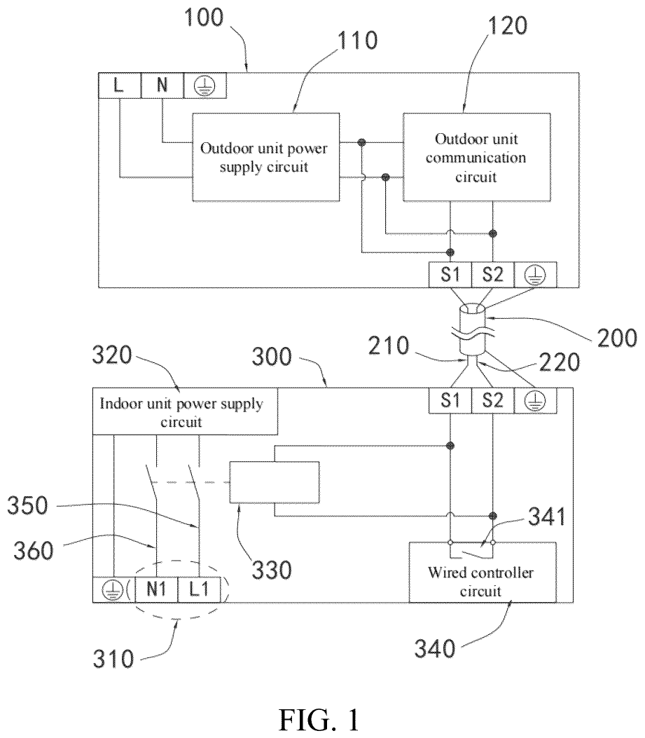

Referring to FIG. 1, some embodiments of the present disclosure provide an air conditioning circuit, including an outdoor unit circuit 100, a carrier communication cable 200, and an indoor unit circuit 300.

The outdoor unit circuit 100 includes an outdoor unit power supply circuit 110.

The carrier communication cable 200 is connected to an output terminal of the outdoor unit power supply circuit 110 to obtain carrier power.

The indoor unit circuit 300 includes a power supply input terminal 310, an indoor unit power supply circuit 320, a switching device 330, and a wired controller circuit 340. The indoor unit power supply circuit 320 obtains power from the power supply input terminal 310 through the switching device 330, a control terminal of the switching device 330 is connected to the carrier communication cable 200, the wired controller circuit 340 is connected to the carrier communication cable 200 to obtain power, the wired controller circuit 340 is provided with a standby switch 341 connected to the carrier communication cable 200, and the standby switch 341 is configured to, when closed, trigger an overload protection function of the outdoor unit power supply circuit 110 through the carrier communication cable 200. The standby switch 341 may be a conventional mechanical switch with state retention, or may be another switching device having an equivalent function.

It may be understood that, usually, an air conditioning system, such as a multi-split system, includes an outdoor unit and a plurality of indoor units. In the embodiment shown in FIG. 1, one indoor unit is used as an example, an outdoor unit includes the outdoor unit circuit 100, and the indoor unit includes an indoor unit circuit 300. In this embodiment, as shown in FIG. 1, the outdoor unit circuit 100 further includes a power supply input terminal, and the power supply input terminal includes a line input terminal L and a neutral input terminal N, that is, the outdoor unit circuit 100 obtains alternating current power through the line input terminal L and the neutral input terminal N. It should be noted that the outdoor unit power supply circuit 110 may convert 220V mains alternating current power into lower-voltage alternating current power, or may convert alternating current power into direct current power. Therefore, the outdoor unit power supply circuit 110 may be configured with a plurality of sets of output terminals, such as an alternating current output terminal and a direct current output terminal. Correspondingly, the outdoor unit of the air conditioner system may alternatively include a plurality of other loads, such as an alternating current fan, a temperature sensor, a humidity sensor, a water level detection sensor, and an electric control valve. These loads on the outdoor unit of the air conditioning system usually obtain power from the output terminal of the outdoor unit power supply circuit 110. Similarly, the indoor unit circuit includes the power supply input terminal 310, and the power supply input terminal 310 includes a line input terminal L1 and a neutral input terminal N1, that is, the indoor unit obtains alternating current power through the line input terminal L1 and the neutral input terminal N1. The line input terminal L1 and the neutral input terminal N1 are further connected to an input terminal of the indoor unit power supply circuit 320, thereby transmitting the obtained alternating current power to the indoor unit power supply circuit 320. It should be noted that the indoor unit power supply circuit 320 may convert 220V mains alternating current power into lower-voltage alternating current power, or may convert alternating current power into direct current power. Therefore, the indoor unit power supply circuit 320 may be configured with a plurality of sets of output terminals, such as an alternating current output terminal and a direct current output terminal. Correspondingly, the indoor unit of the air conditioning system usually includes a plurality of other loads, such as an alternating current fan, an air outlet panel drive motor, an air return panel drive motor, a fresh air valve drive motor, a temperature sensor, a humidity sensor, and a water level detection sensor. These loads on the indoor unit of the air conditioning system usually obtain power from the output terminal of the indoor unit power supply circuit 320.

In addition, it may be understood that both the outdoor unit power supply circuit 110 and the indoor unit power supply circuit 320 may be a switching power supply circuit.

According to the air conditioning circuit provided in the embodiments of the present disclosure, when the air conditioning system operates normally, in the outdoor unit circuit 100, the outdoor unit power supply circuit 110 operates normally, and the output terminal of the outdoor unit power supply circuit 110 provides the carrier power to the carrier communication cable 200; and in the indoor unit circuit 300, the carrier communication cable 200 outputs the power to the switching device 330 and the wired controller circuit 340, which can enable the switching device 330 to be in the activated state, such that the power from the power supply input terminal 310 can be supplied to the indoor unit power supply circuit 320 through the switching device 330, allowing both the indoor unit power supply circuit 320 and the wired controller circuit 340 to be powered up and operate normally. When the air conditioning system needs to enter the standby state, the user can press the standby switch 341 in the wired controller circuit 340 to close the standby switch 341, thereby triggering the overload protection function of the outdoor unit power supply circuit 110, such that the outdoor unit power supply circuit 110 enters the overload protection state. To be specific, the outdoor unit power supply circuit 110 does not operate, all the outdoor unit loads connected to the outdoor unit power supply circuit 110 do not operate at this time, the carrier communication cable 200 does not supply the power to the switching device 330 and the wired controller circuit 340, the switching device 330 also changes from the activated state to the deactivated state, and consequently, the power from the power supply input terminal 310 cannot be supplied to the indoor unit power supply circuit 320 through the switching device 330, the indoor unit power supply circuit 320 does not operate, and all the indoor unit loads connected to the indoor unit power supply circuit 320 do not operate at this time. The air conditioning circuit utilizes the standby switch 341 to trigger the overload protection function of the outdoor unit power supply circuit 110, and after the standby switch 341 is pressed to enter the standby state, all the switching power supply circuits and the loads in the air conditioning system do not operate, thereby achieving ultra-low standby power consumption control for the air conditioning system, low costs, and ease of implementation.

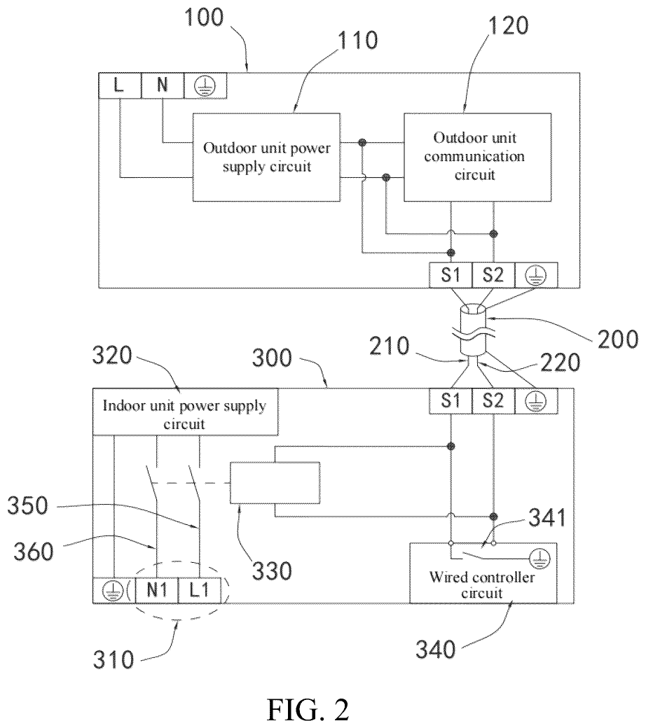

Referring to FIG. 2, in an air conditioning circuit according to another embodiment of the present disclosure, the air conditioning circuit includes an outdoor unit circuit 100, a carrier communication cable 200, and an indoor unit circuit 300. The outdoor unit circuit 100 includes an outdoor unit power supply circuit 110. The carrier communication cable 200 is connected to an output terminal of the outdoor unit power supply circuit 110 to obtain carrier power. The indoor unit circuit 300 includes a power supply input terminal 310, an indoor unit power supply circuit 320, a switching device 330, and a wired controller circuit 340. The indoor unit power supply circuit 320 obtains power from the power supply input terminal 310 through the switching device 330, a control terminal of the switching device 330 is connected to the carrier communication cable 200, the wired controller circuit 340 is connected to the carrier communication cable 200 to obtain power, the wired controller circuit 340 is provided with a standby switch 341 connected to the carrier communication cable 200, and the standby switch 341 is configured to, when closed, trigger an overload protection function of the outdoor unit power supply circuit 110. The carrier communication cable 200 includes a first cable 210 connected to a positive output terminal of the outdoor unit power supply circuit 110, one end of the standby switch 341 is connected to the first cable 210, and the other end of the standby switch 341 is grounded.

In this embodiment, when the standby switch 341 in the wired controller circuit 340 is pressed, the positive output terminal of the outdoor unit power supply circuit 110 is grounded through the first cable 210 and the standby switch 341. Because only resistance of the first cable 210 exists between the positive output terminal of the indoor unit power supply circuit 120 and the ground, and the resistance of the cable is very small, output power of the outdoor unit power supply circuit 110 becomes excessively high, thereby triggering the overload protection function of the outdoor unit power supply circuit 110, such that the outdoor unit power supply circuit 110 enters an overload protection state. To be specific, the outdoor unit power supply circuit 110 does not operate, all loads, including the carrier communication cable 200 that obtains the carrier power from the output terminal of the outdoor unit power supply circuit 110, connected to the outdoor unit power supply circuit 110 do not operate at this time, loss of power in the carrier communication cable 200 causes the switching device 330 to change from an activated state to a deactivated state, the power supply input terminal 310 in the indoor unit circuit 300 cannot supply power to the indoor unit power supply circuit 320, and all loads connected to the indoor unit power supply circuit 320 do not operate at this time.

Referring to FIG. 1, in the air conditioning circuit according to some embodiments of the present disclosure, the carrier communication cable 200 includes a first cable 210 connected to a positive output terminal of the outdoor unit power supply circuit 110 and a second cable 220 connected to a negative output terminal of the outdoor unit power supply circuit 110, one end of the standby switch 341 is connected to the first cable 210, and the other end of the standby switch 341 is connected to the second cable 220.

In this embodiment, unlike the embodiment of FIG. 2, in the embodiment of FIG. 2, a short-circuit loop is formed by grounding through the wired controller circuit 340 when the standby switch 341 is pressed, while in this embodiment, a short-circuit loop is formed between the positive output terminal and the negative output terminal that are of the outdoor unit power supply circuit 110 through the first cable 210, the standby switch 341, and the second cable 220 when the standby switch 341 is pressed. Because only resistance of the first cable 140 and the second cable 150 exists between the positive output terminal and the negative output terminal that are of the outdoor unit power supply circuit 110, and the resistance of the cable is very small, output power of the outdoor unit power supply circuit 110 becomes excessively high, thereby triggering the overload protection function of the outdoor unit power supply circuit 110, such that the outdoor unit power supply circuit 110 enters an overload protection state. To be specific, the outdoor unit power supply circuit 110 does not operate, all loads, including the carrier communication cable 200 that obtains the carrier power from the output terminal of the outdoor unit power supply circuit 110, connected to the outdoor unit power supply circuit 110 do not operate at this time, loss of power in the carrier communication cable 200 causes the switching device 330 to change from an activated state to a deactivated state, the power supply input terminal 310 in the indoor unit circuit 300 cannot supply power to the indoor unit power supply circuit 320, and all loads connected to the indoor unit power supply circuit 320 do not operate at this time.

It should be further noted that the output power of the outdoor unit power supply circuit 110 is greater than the output overload power of the outdoor unit power supply circuit 110 when the standby switch 341 is closed. It may be understood that when selecting the outdoor unit power supply circuit 110 or designing the outdoor unit power supply circuit 110, it is necessary to ensure that the output power of the outdoor unit power supply circuit 110 is greater than the output overload power of the outdoor unit power supply circuit 110 when the standby switch 341 is closed. This ensures that when the standby switch 341 is closed, the outdoor unit power supply circuit 110 can enter the overload protection state and does not operate, thereby supplying no power to other loads.

Referring to FIG. 1 and FIG. 2, in the air conditioning circuit according to some embodiments of the present disclosure, the switching device 330 is a relay or a contactor.

In this embodiment, when the relay is used as the switching device 330, a coil of the relay is connected to the carrier communication cable 200. When the outdoor unit power supply circuit 110 operates normally and can supply carrier power to the carrier communication cable 200, the coil of the relay can obtain power from the carrier communication cable 200, to enable the relay to operate, such that a contact of the relay is closed, and power from the power supply input terminal 310 can be supplied to the indoor unit power supply circuit 320. Similarly, when the contactor is used as the switching device 330, a coil of the contactor is connected to the carrier communication cable 200. When the outdoor unit power supply circuit 110 operates normally and can supply carrier power to the carrier communication cable 200, the coil of the contactor can obtain power from the carrier communication cable 200, to enable the contactor to operate, such that a contact of the contactor is closed, and power from the power supply input terminal 310 can be supplied to the indoor unit power supply circuit 320.

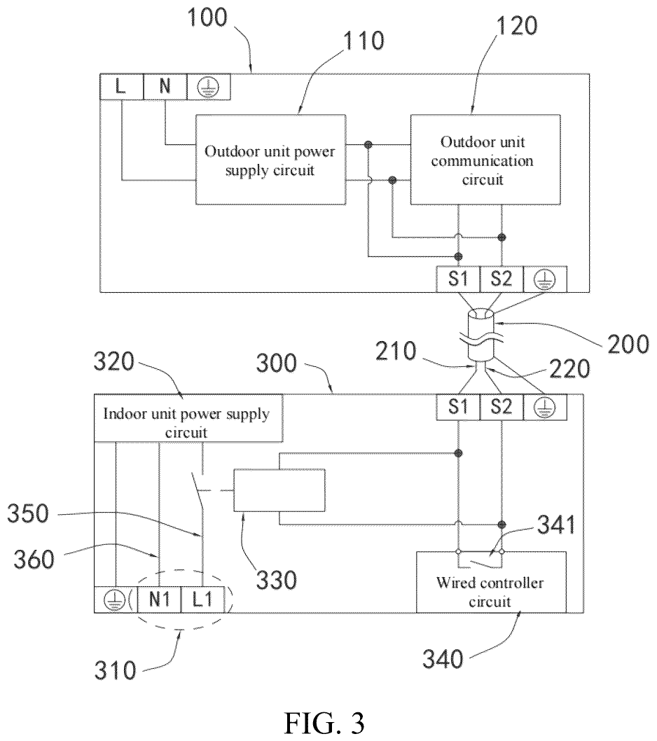

Referring to FIG. 3, in the air conditioning circuit according to some embodiments of the present disclosure, the power supply input terminal 310 includes a line input terminal L1 and a neutral input terminal N1, the line input terminal L1 is connected to the indoor unit power supply circuit 320 through a third cable 350, the neutral input terminal N1 is connected to the indoor unit power supply circuit 320 through a fourth cable 360, the switching device 330 includes a first normally-open contact connected in series in the third cable 350, and a coil of the switching device 330 is connected to the carrier communication cable 200.

In this embodiment, when the switching device 330 operates, the first normally-open contact connected in series in the third cable 350 is closed, such that the line input terminal L1 and the neutral input terminal N1 can supply power to the indoor unit power supply circuit 320 through the third cable 350 and the fourth cable 350, allowing the indoor unit power supply circuit 320 to be powered up and operate normally. When an outdoor unit power supply circuit 110 does not operate, the coil of the relay 330 is de-energized, the relay 330 no longer maintains an activated state, the first normally-open contact connected in series in the third cable 350 returns to an open state, the line input terminal L1 cannot be connected to the indoor unit power supply circuit 320, and the indoor unit power supply circuit 320 cannot be powered up and operate.

Referring to FIG. 1 and FIG. 2, in the air conditioning circuit according to some embodiments of the present disclosure, the power supply input terminal 310 includes the line input terminal L1 and the neutral input terminal N1, the line input terminal L1 is connected to the indoor unit power supply circuit 320 through a third cable 350, the neutral input terminal N1 is connected to the indoor unit power supply circuit 320 through a fourth cable 360, the switching device 330 includes a first normally-open contact connected in series in the third cable 350, a coil of the switching device 330 is connected to the carrier communication cable 200, and the switching device 330 further includes a second normally-open contact connected in series in the fourth cable 360.

Unlike the embodiment shown in FIG. 3, in this embodiment, the two normally-open contacts of the switching device 330 are connected in series in the third cable 350 and the fourth cable 360, respectively. When the outdoor unit power supply circuit 110 does not operate, the coil of the switching device 330 is de-energized, the switching device 330 no longer maintains the activated state, both the first normally-open contact connected in series in the third cable 350 and the second normally-open contact connected in series in the fourth cable 360 return to an open state, and the power supply input terminal 310 is completely disconnected from the indoor unit switching circuit 320, thereby providing higher reliability, such that the indoor unit power supply circuit 320 cannot be powered up and operate.

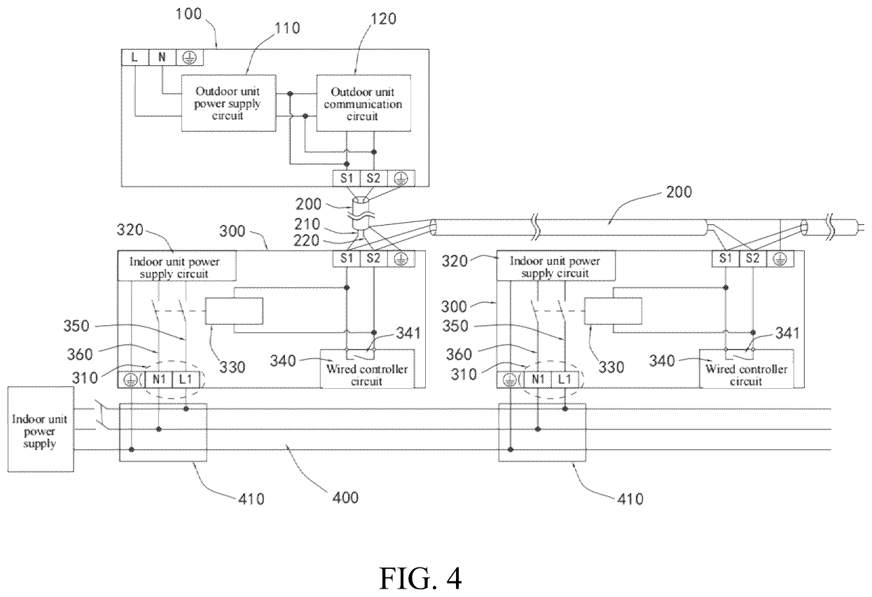

Referring to FIG. 4, in the air conditioning circuit according to some embodiments of the present disclosure, a plurality of indoor unit circuits 300 are provided, and control terminals of switching devices 330 in the plurality of indoor unit circuits 300 are all connected to the carrier communication cable 200. It should be noted that when the switching device 330 is a relay or a contactor, the control terminal of the switching device 330 is a coil connection terminal of the relay or the contactor.

In a multi-split system, a plurality of indoor units are usually provided, and the indoor unit circuits 300 in the plurality of indoor units all communicate with an outdoor unit circuit 100 through the carrier communication cable 200. The control terminals of the switching devices 330 in the plurality of indoor unit circuits 300 are all connected to the carrier communication cable 200, such that when the carrier communication cable 200 is de-energized, each indoor unit cannot be powered up and operate because the switching devices 330 no longer maintains an activated state.

Referring to FIG. 4, the air conditioning circuit according to some embodiments of the present disclosure further includes an indoor unit power supply cable 400 connected to an indoor unit power supply. The indoor unit power supply cable 400 is provided with a plurality of distribution boxes 410 for supplying power to the power supply input terminal 310.

In this embodiment, the indoor unit power supply provides motive power to the indoor unit power supply cable 400, a power supply input terminal 310 of each indoor unit circuit 300 may obtain power from the indoor unit power supply cable 400, and arrangement of the distribution boxes 410 on the indoor unit power supply cable 400 can facilitate wiring connection. It may be understood that one main switch may also be provided on the indoor unit power supply cable 400. When the main switch is turned off, all the indoor unit circuits 300 cannot obtain power supply.

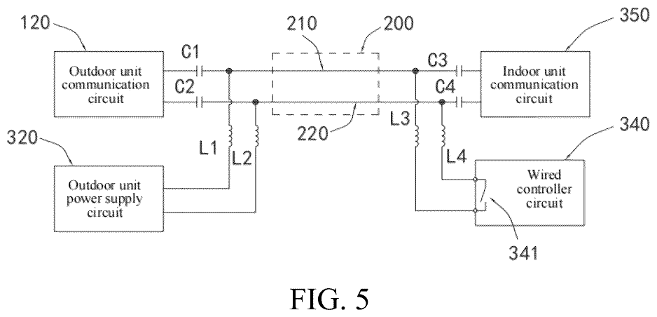

Referring to FIG. 5, in the air conditioning circuit according to some embodiments of the present disclosure, the outdoor unit circuit 100 further includes an outdoor unit communication circuit 120 coupled to the carrier communication cable 200, and the indoor unit circuit 300 further includes an indoor unit communication circuit 350 coupled to the carrier communication cable 200.

In this embodiment, in addition to transmitting carrier power, the carrier communication cable 200 may further transmit a communication signal. By being coupled to the carrier communication cable 200, the outdoor unit communication circuit 120 of the outdoor unit circuit 100 couples the communication signal onto the carrier communication cable 200 or obtains, through the carrier communication cable 200, the communication signal sent from the indoor unit communication circuit 350. Similarly, by being coupled to the carrier communication cable 200, the indoor unit communication circuit 350 of the indoor unit circuit 300 couples the communication signal onto the carrier communication cable 200 or obtains, through the carrier communication cable 200, the communication signal sent from the outdoor unit communication circuit 120.

Referring to FIG. 5, in the air conditioning circuit according to some embodiments of the present disclosure, the outdoor unit communication circuit 120 is connected to the first cable 210 through a first capacitor C1 and to the second cable 220 through a second capacitor C2; and the indoor unit communication circuit 350 is connected to the first cable 210 through a third capacitor C3 and to the second cable 220 through a fourth capacitor C4.

In this embodiment, in one aspect, the first capacitor C1 and the second capacitor C2 may couple, onto the first cable 210 and the second cable 220, the communication signal sent from the outdoor unit communication circuit 120, and in another aspect, the first capacitor C1 and the second capacitor C2 may provide isolation against carrier power on the first cable 210 and the second cable 220. Similarly, in one aspect, the third capacitor C3 and the fourth capacitor C4 may couple, onto the first cable 210 and the second cable 220, the communication signal sent from the indoor unit communication circuit 350, and in another aspect, the third capacitor C3 and the fourth capacitor C4 may provide isolation against carrier power on the first cable 210 and the second cable 220.

Referring to FIG. 5, in the air conditioning circuit according to some embodiments of the present disclosure, the positive output terminal of the outdoor unit power supply circuit 110 is connected to the first cable 210 through a first inductor L1, and the negative output terminal of the outdoor unit power supply circuit 110 is connected to the second cable 220 through a second inductor L2; and the first cable 210 is connected to the one end of the standby switch 341 through a third inductor L3, and the second cable 220 is connected to the other end of the standby switch 341 through a fourth inductor L4.

In this embodiment, in one aspect, the first inductor L1 and the second inductor L2 may couple carrier power provided by the outdoor unit power supply circuit 110 onto the first cable 210 and the second cable 220, and in another aspect, the first inductor L1 and the second inductor L2 may provide isolation against the communication signal on the first cable 210 and the second cable 220. Similarly, in one aspect, the third inductor L3 and the fourth inductor L4 may couple the carrier power on the first cable 210 and the second cable 220 to a wired controller circuit 340, and in another aspect, the third inductor L3 and the fourth inductor L4 may provide isolation against the communication signal on the first cable 210 and the second cable 220.

According to a second aspect of the present disclosure, an embodiment provides a multi-split system, including an inner unit, an outer unit, and the air conditioning circuit according to the embodiments of the first aspect. The inner unit includes the indoor unit circuit 300 in the air conditioning circuit, and the outer unit includes the outdoor unit circuit 100 in the air conditioning circuit.

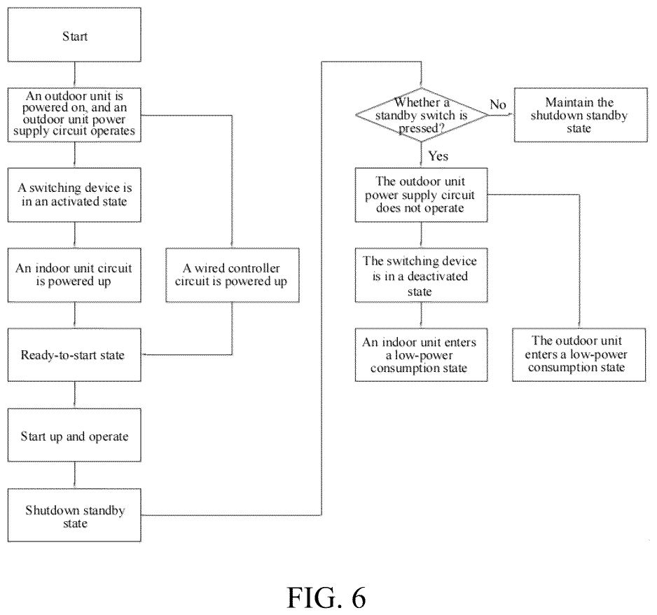

Referring to FIG. 6, FIG. 6 is a schematic diagram illustrating state switching of the multi-split system according to this embodiment of the present disclosure. The outdoor unit is powered on, and an outdoor unit power supply circuit 110 starts operating, and supplies carrier power to a carrier communication cable 200. Then, a switching device 330 is in an operational state, and a wired controller circuit 340 is powered up. Subsequently, the indoor unit circuit 300 is powered up. In this case, the multi-split system is in a ready-to-start state. A user may control, by operating a wired controller, the multi-split system to start up and operate. After the multi-split system completes operation, the user may control, by operating the wired controller, the multi-split system to enter a shutdown standby state. In this case, an indoor unit power supply circuit 320 and the outdoor unit power supply circuit 110 remain powered on and are in an operational state. Subsequently, it is determined whether a standby switch 341 is pressed. If the standby switch 341 is not pressed, the multi-split system maintains the shutdown standby state. If the standby switch 341 is pressed, the outdoor unit power supply circuit 110 does not operate, the outdoor unit enters a low-power consumption state, the switching device 330 changes to a deactivated state, and the indoor unit also enters a low-power consumption state.

According to the multi-split system provided by the embodiment of the present disclosure, when an air conditioning system operates normally, in the outdoor unit circuit 100, the outdoor unit power supply circuit 110 operates normally, and an output terminal of the outdoor unit power supply circuit 110 supplies the carrier power to the carrier communication cable 200; and in the indoor unit circuit 300, the carrier communication cable 200 outputs power to the switching device 330 and the wired controller circuit 340, which can enable the switching device 330 to be in an activated state, such that power from a power supply input terminal 310 can be supplied to the indoor unit power supply circuit 320 through the switching device 330, allowing both the indoor unit power supply circuit 320 and the wired controller circuit 340 to be powered up and operate normally. When the air conditioning system needs to enter a standby state, the user can press the standby switch 341 in the wired controller circuit 340 to close the standby switch 341, thereby triggering an overload protection function of the outdoor unit power supply circuit 110, such that the outdoor unit power supply circuit 110 enters an overload protection state. To be specific, the outdoor unit power supply circuit 110 does not operate, all outdoor unit loads connected to the outdoor unit power supply circuit 110 do not operate at this time, the carrier communication cable 200 no longer supplies the power to the switching device 330 and the wired controller circuit 340 in the indoor unit circuit 300, the switching device 330 also changes from the activated state to the deactivated state, and consequently, the power from the power supply input terminal 310 cannot be supplied to the indoor unit power supply circuit 320 through the switching device 330, the indoor unit power supply circuit 320 does not operate, all indoor unit loads connected to the indoor unit power supply circuit 320 do not operate at this time, and the wired controller circuit 340 does not operate. The air conditioning circuit utilizes the standby switch 341 to trigger the overload protection function of the outdoor unit power supply circuit 110, and after the standby switch 341 is pressed to enter the standby state, all the switching power supply circuits and the loads in the air conditioning system do not operate, thereby achieving ultra-low standby power consumption control for the air conditioning system, low costs, and ease of implementation.

Although some embodiments of the present disclosure are described in detail above with reference to the accompanying drawings, the present disclosure is not limited to the foregoing embodiments, and various changes can be made within the knowledge scope of those having ordinary skills in the art without departing from the principle of the present disclosure.

1.-12. (canceled)

13. An air conditioning circuit comprising:
an outdoor unit circuit, including an outdoor unit power supply circuit;
a carrier communication cable, connected to an output terminal of the outdoor unit power supply circuit; and
an indoor unit circuit, including:
a power supply input terminal;
a switching device, a control terminal of the switching device being connected to the carrier communication cable;
an indoor unit power supply circuit configured to obtain power from the power supply input terminal through the switching device; and
a wired controller circuit connected to the carrier communication cable, the wired controller circuit including a standby switch connected to the carrier communication cable and configured to, in response to being closed, trigger an overload protection function of the outdoor unit power supply circuit through the carrier communication cable.

14. The air conditioning circuit of claim 13, wherein the carrier communication cable includes a cable connected to a positive output terminal of the outdoor unit power supply circuit, one end of the standby switch is connected to the cable, and another end of the standby switch is grounded.

15. The air conditioning circuit of claim 13, wherein the carrier communication cable includes a first cable connected to a positive output terminal of the outdoor unit power supply circuit and a second cable connected to a negative output terminal of the outdoor unit power supply circuit, one end of the standby switch is connected to the first cable, and another end of the standby switch is connected to the second cable.

16. The air conditioning circuit of claim 13, wherein the switching device includes a relay or a contactor.

17. The air conditioning circuit of claim 16, wherein the power supply input terminal includes a line input terminal and a neutral input terminal, the line input terminal is connected to the indoor unit power supply circuit through a first cable, the neutral input terminal is connected to the indoor unit power supply circuit through a second cable, the switching device includes a normally-open contact connected in series in the first cable, and a coil of the switching device is connected to the carrier communication cable.

18. The air conditioning circuit of claim 17, wherein the normally-open contact is a first normally-open contact, and the switching device further includes a second normally-open contact connected in series in the second cable.

19. The air conditioning circuit according to claim 13, wherein the indoor unit circuit is one of a plurality of indoor unit circuits of the air conditioning circuit, and control terminals of switching devices of the plurality of indoor unit circuits are all connected to the carrier communication cable.

20. The air conditioning circuit of claim 19, further comprising:
an indoor unit power supply cable connected to an indoor unit power supply and including a plurality of distribution boxes for supplying power to the power supply input terminal.

21. The air conditioning circuit of claim 13, wherein the outdoor unit circuit further includes an outdoor unit communication circuit coupled to the carrier communication cable, and the indoor unit circuit further includes an indoor unit communication circuit coupled to the carrier communication cable.

22. The air conditioning circuit of claim 21, wherein:
the carrier communication cable includes a first cable connected to a positive output terminal of the outdoor unit power supply circuit through a first capacitor and a second cable connected to a negative output terminal of the outdoor unit power supply circuit through a second capacitor, one end of the standby switch is connected to the first cable, and another end of the standby switch is connected to the second cable; and
the indoor unit communication circuit is connected to the first cable through a third capacitor and to the second cable through a fourth capacitor.

23. The air conditioning circuit of claim 21, wherein:
the carrier communication cable includes a first cable connected to a positive output terminal of the outdoor unit power supply circuit through a first inductor and a second cable connected to a negative output terminal of the outdoor unit power supply circuit through a second inductor; and
one end of the standby switch is connected to the first cable through a third inductor, and another end of the standby switch is connected to the second cable through a fourth inductor.

24. A multi-split system comprising:
an inner unit;
an outer unit; and
an air conditioning circuit including:
an outdoor unit circuit provided at the outer unit and including an outdoor unit power supply circuit;
a carrier communication cable, connected to an output terminal of the outdoor unit power supply circuit; and
an indoor unit circuit provided at the inner unit and including:
a power supply input terminal;
a switching device, a control terminal of the switching device being connected to the carrier communication cable;
an indoor unit power supply circuit configured to obtain power from the power supply input terminal through the switching device; and
a wired controller circuit connected to the carrier communication cable, the wired controller circuit including a standby switch connected to the carrier communication cable and configured to, in response to being closed, trigger an overload protection function of the outdoor unit power supply circuit through the carrier communication cable.

25. The multi-split system of claim 24, wherein the carrier communication cable includes a cable connected to a positive output terminal of the outdoor unit power supply circuit, one end of the standby switch is connected to the cable, and another end of the standby switch is grounded.

26. The multi-split system of claim 24, wherein the carrier communication cable includes a first cable connected to a positive output terminal of the outdoor unit power supply circuit and a second cable connected to a negative output terminal of the outdoor unit power supply circuit, one end of the standby switch is connected to the first cable, and another end of the standby switch is connected to the second cable.

27. The multi-split system of claim 24, wherein the switching device includes a relay or a contactor.

28. The multi-split system of claim 27, wherein the power supply input terminal includes a line input terminal and a neutral input terminal, the line input terminal is connected to the indoor unit power supply circuit through a first cable, the neutral input terminal is connected to the indoor unit power supply circuit through a second cable, the switching device includes a normally-open contact connected in series in the first cable, and a coil of the switching device is connected to the carrier communication cable.

29. The multi-split system of claim 28, wherein the normally-open contact is a first normally-open contact, and the switching device further includes a second normally-open contact connected in series in the second cable.

30. The multi-split system of claim 24, wherein the indoor unit circuit is one of a plurality of indoor unit circuits of the air conditioning circuit, and control terminals of switching devices of the plurality of indoor unit circuits are all connected to the carrier communication cable.

31. multi-split system of claim 30, wherein the air conditioning circuit further includes:
an indoor unit power supply cable connected to an indoor unit power supply and including a plurality of distribution boxes for supplying power to the power supply input terminal.

32. The multi-split system of claim 24, wherein the outdoor unit circuit further includes an outdoor unit communication circuit coupled to the carrier communication cable, and the indoor unit circuit further includes an indoor unit communication circuit coupled to the carrier communication cable.
